(19) United States
(12) Patent Application Publication
(10) Pub. No.: US 2003/0139180 A1
(43) Pub. Date: Jul. 24, 2003

(54) Private cellular network with a public network interface and a wireless local area network extension

(76) Inventors: Chris P. McIntosh, San Francisco, CA (US); Priscilla Marilyn Lu, San Carlos, CA (US); Rupak Chandra, Mountain View, CA (US); Rahul Jain, Mountain View, CA (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 10/126,250

(22) Filed: Apr. 19, 2002

Related U.S. Application Data
(60) Provisional application No. 60/351,764, filed on Jan. 24, 2002.
(60) Provisional application No. 60/357,723, filed on Feb. 15, 2002.

(51) Int. Cl. H04Q 7/20; H04M 1/00; H04B 1/38

(52) U.S. Cl. 455/426; 455/554; 455/555

(57) ABSTRACT

A communication system (100) and method for coupling a wireless local area network (WLAN 128) to a public network (102) to enable communication between User Equipment terminals (UEs 130) associated with the WLAN and the public network. The public network (102) can include a GSM (110) and/or a 3G-network (114). The WLAN (128) can include a HiperLAN, HiperMAN, or 802.11 network. Preferably, the communication is voice communication, and the system (100) is configured to enable the UEs (130) to access supplementary services provided by the public network (102). Subscriber and security information for the UEs (102) can be provided to the public network (102) from a SIM (134) associated with each UE, or from an identity module (138) comprising either a private memory with information stored therein, or a card holder/reader holding cards with subscriber and security information for one or more UEs. Optionally, the system (100) further includes a private cellular network (122) the WLAN (128) also enables communication between the UEs (130) and the private cellular network.

### REFERENCE TO RELATED APPLICATIONS

This application claims priority to U.S. Provisional Application Serial No. 60/351,764, entitled Private Wireless Network With a Public Network Interface and a Wireless Local Area Network Extension, filed Jan. 24, 2002, and to U.S. Provisional Application Serial No. 60/357,723, entitled Private Wireless Network With a Public Network Interface and a Wireless Local Area Network Extension, filed Feb. 15, 2002, both of which are incorporated herein by reference.

### FIELD

The present invention relates generally to communication systems, and more particularly to a communication system and a method for using the same to couple a wireless local area network (WLAN) to public and private telephone networks to enable communication between user equipment terminals associated with the WLAN and the telephone networks.

### BACKGROUND

The use of wireless communication networks and devices, including mobile telephones, pagers, facsimile machines, computers and network access appliances, has increased exponentially in recent years. This increased demand for wireless communication networks and devices has led to rapid growth in the public and private infrastructures required to support these services. Public networks include wired networks such as the public switched telephone network (PSTN) and the Internet, and wireless or cellular networks, such as global system for mobile communications (GSM) networks and third-generation mobile communications (3G) networks. In addition, many GSM networks include a packet-switched technology, such as General Packet Radio Service (GPRS), to provide wireless data access.

Private networks include wired networks, such as private branch exchanges (PBXs), and private wireless or cellular networks, such as private GSM networks, private 3G-networks and cordless networks, such as DEC. Private networks may or may not interface with a public cellular network to facilitate communication between public and private mobile stations (MS) or user equipment terminals (UEs). Private cellular networks generally use the same type of base transceiver station or radio as the public cellular networks, and the same or similar handsets or mobile stations. Therefore, private cellular networks operate in a regulated frequency band, and require costly licenses to operate in the heavily utilized bands for cellular communication. Thus, private cellular networks are generally expensive to install and operate.

Another type of private network, known as a wireless local area network (WLAN), is commonly used to link data processing systems or UEs in or to a data network at a particular geographic location or site, for the wireless communication of data. WLANs generally employ communication technology and standards capable of providing high performance broadband, which is high-speed and high-bandwidth communication of data, which enables video streaming, audio streaming, and transfer or downloading large files or attachments. Moreover, in contrast to the public and private cellular networks described above, WLANs have less expensive low power radios and UEs, that have a shorter operational range, and operate in an unregulated frequency band. However, WLANs lack the capability of interfacing with the public cellular network authentication and encryption mechanisms that ensure security, allow tracking of customer usage and enable the roaming capabilities of UEs within the public cellular network.

Consequently, one problem with existing communication systems is that companies or enterprise, which may already have an existing WLAN for wireless communication of data, are prohibited by cost from providing cellular communication in or over the same geographic area. In some locations cellular communication may be available over a public cellular network, however this can result in the accruing of substantial toll charges for calls between mobile stations and/or UEs within a single WLAN site or between mobile stations and/or UEs at separate WLAN sites linked through wide area networks (WANs). Moreover, this in turn leads to many other disadvantages including an inability to maintain ownership or control of information transferred over the public cellular network, and inefficient use of system resources due to unnecessary backhauling of communications between two mobile stations or UEs at a single site to a switching center in the public cellular network.

Another problem with existing communication systems is that the increased demand for voice and data communication services has outpaced the growth in GSM networks and 3G networks and the public infrastructure required to support these services. Moreover, continued growth of wireless or cellular communication systems in general and the success of broadband cellular communication systems in particular, requires a system capable of providing high performance, high-speed and high-bandwidth communication. In addition, it is desirable that such a system make use of existing public network and Internet network infrastructures. That is it must be compatible with simple, standardized internet protocol (IP) based communication systems.

Accordingly, there is a need for a communication system and method that bridges the gap between existing public cellular networks, including GSM/GPRS cellular networks and 3G cellular networks, and existing WLANs, providing the authentication and roaming capabilities of the public cellular network with the high-speed and high-bandwidth of WLAN technology. In particular, there is a need for a system and method for facilitating communication, including voice communication, video streaming and audio streaming, and transfer or downloading large files or attachments, between UEs of an existing WLAN and terminals, such as UEs, MS, telephones and data processing systems coupled to the public network. There is a further need for a system and method that ensures interoperability between GSM/3G standards and the IP standards of the WLAN to deliver maximum network security, authentication and encryption, and seamless supplementary feature transparency. There is a still further need for a system and method that enables tracking of customer usage and billing for UEs coupled to the public network over the WLAN. It is also desirable that the system and method transparently directs or re-directs WLAN users to broadband services offered by operators of the public network when required, thereby enabling them to capture an established user base.

The system and method of the present invention provides these and other advantages over the prior art.

### SUMMARY

It is an object of the present invention to provide a communication system that bridges the gap between an existing public network and WLANs to provide authentication and roaming capabilities of the former with the high-speed and high-bandwidth of the latter.

It is a further object of the present invention to provide a communication system in which a UE terminal of a WLAN operating in an unregulated frequency band is able to access a public network, such as a public switched telephone network, a public GSM cellular network, public 3G network, or the Internet, and/or a private network, such as a private cellular network, a campus or enterprise 3G network, or a private branch exchange (PBX) with a functionality and capabilities similar to those available from mobile stations of more expensive GSM cellular networks and 3G cellular networks.

It is a still further object of the present invention to provide a communication system in which GSM/GPRS/3G broadband services are provided using WLAN broadband technology and in particular using 802.11 based technology.

In one aspect, the present invention is directed to communication system which enables a user to access a public network through low powered unregulated user equipment terminals (UEs) or transceivers. Generally, the communication system includes a public cellular network and a wireless local area network (WLAN) coupled to the public cellular network, the WLAN configured to facilitate communication between the UEs and the public cellular network. The public cellular network can be a global system for mobile communications (GSM) network coupled to a public switched telephone network (PSTN). Alternatively, the public cellular network can further include a third-generation mobile communications (3G) network coupled to the GSM network and to the Internet. Optionally, the communication system further includes a private cellular network coupled to the WLAN to facilitate communication between the UEs and mobile stations associated with the private cellular network.

In one embodiment, the communication system further comprises a Remote Authentication Dial In User Service (RADIUS) server to authenticate UEs accessing the communication system through the WLAN and to authorize access to the communication system. Where the communication system includes multiple linked WLANs, a home location registry (HLR), including, for example, a home location register and/or a home subscription sever, and visitor location registry (VLR) coupled to the RADIUS server provide roaming capabilities for the UEs among the plurality of WLANs.

In another embodiment, the UE includes a computer program to enable it to access and control supplementary services and/or value-added services provided by the public and/or private network. Supplementary services include, for example, Voice Group Call Service, Voice Broadcast Service, Service definition Line Identification Supplementary Services, Call Forwarding Supplementary Services, Call Waiting and Call Hold Supplementary Services, Multiparty call conferencing, Closed User Group Supplementary Services, Advice of Charge Supplementary Services, Call Barring Supplementary Services, Unstructured Supplementary Service Data, Explicit Call Transfer, Completion of Calls to Busy Subscriber, Short Message Service, and Follow Me. Value-added services include, for example, e-mail, calender, and wireless inventory, etcetera.

Preferably, the WLAN is compatible with one or more high performance wireless communication standards. For example, a European Telecommunications Standards Institute (ETSI) standard for Broadband Radio Access Networks (BRAN), such as a high performance local area network (HiperLAN/1), HiperLAN/2, or a high performance Metropolitan Access Network (HiperMAN). Other examples, include Institute of Electrical and Electronics Engineers 802.11 standards (IEEE 802.11), such as 802.11(a) and 802.11(b).

A communication system according to the present invention is particularly useful to operators of hotels, hotel chains, airports, airport building maintenance, and other like enterprises for deployment of in-building broadband RF services, or for users of UEs with e-mail messaging capabilities. In another aspect, the present invention is directed to a method of enabling a number of UEs to communicate with a public network and/or private network via the WLAN. Generally, the method includes steps of: receiving in the WLAN call information to or from one of the number of UEs; providing subscriber identification and security information for the UE to an authentication server; and coupling the UE to the public network or private network over the WLAN.

Preferably, the communication between the UEs and the public cellular network facilitated by the WLAN includes voice communication. More preferably, the UE further includes computer program necessary to access or control supplementary services and/or value added services provided by the public network or private network, and the method further includes the step of controlling such supplementary services and/or value added services.

In one embodiment, the UE further includes a memory system having subscriber identification and security information stored therein, and the step of providing subscriber identification and security information for the UE to the authentication server is accomplished by providing subscriber identification and security information associated from the memory system. Alternatively, the UE further includes or is coupled to a card holder/reader holding a number of GSM-type SIM cards or 3G-type USIM cards, and the step of providing subscriber identification and security information for the UE to the public cellular network involves reading subscriber identification and security information stored in one of the cards held in the card holder/reader, which may be public network or private network subscription identifiers, or a combination of both public and private subscription data.

The communication system and method of the present invention is particularly useful in public cellular network including a GSM network coupled to a PSTN and/or a 3G-network coupled to a GSM network, to the PSTN and/or to the Internet. The communication system and method provide a means for coupling an 802.11 network coupled to the GSM network and the 3G-network to facilitate communication between a number of UEs and the public cellular network. Generally, the communication system includes means for authenticating and authorizing access to the system. The means for authenticating and authorizing access can include a RADIUS system or server coupled to the communication system through a VLR/RADIUS interface.

Advantages of the apparatus and method of the present invention include any or all of the following:

(i) ability to bridge the gap between existing GSM/GPRS and 3G cellular systems and WLANs by providing high-speed high-bandwidth broadband capabilities to an existing public cellular network using WLAN technology;

(ii) ability to facilitate communication between a UE and a public network, thereby easily and inexpensively providing access for UEs associated with an existing Wireless Local Area Network to the public network;

(iii) ability to facilitate communication between UEs and a private GSM cellular network. 3G-network and/or PBX, thereby easily and inexpensively expanding the private network;

(iv) ability to access and control supplementary services provided by a public network and/or private cellular network for a call between a UE coupled to the public network and/or private cellular network over the WLAN;

(v) ability to exchange authentication credentials encapsulated in extensible authentication protocol (EAP) between a private 802.11 UE and an HLR in a manner similar to GSM based authentication;

(vi) ability to enable the HLR to supply any access point in the WLAN with user specific information, including subscription profiles, quality of service (QoS) information, billing information, etcetera, to enable service differentiation;

(vii) ability to support roaming of UEs over the WLAN based upon a RADIUS/DIAMETER roaming model along with traditional GSM subscriber roaming based upon the mobile application part (MAP) standard for address registration of roamers and inter-system hand-off procedures;

(viii) ability to support roaming interoperability between existing IP and public GSM networks;

(ix) ability to provide controlled access and billing with Call Detail Records (CDR) based billing;

(x) ability to transparently support supplementary services available on an existing public network or private cellular network, for example, short message service (SMS), E-mail and voice messaging;

(xi) ability to seamlessly provide security and authentication with an existing public GSM network;

(xii) ability to bill based on either: (a) an access method selected by the user of the UE, i.e., over a WLAN, over a private GSM or 3G network, or over a public network; (b) an access method automatically selected by the communication system; or (c) the identity or subscriber profile of the calling or called party, or either a public network, a private network, or a combination of a private and public network;

(xiii) ability to not bill based on either: (a) an access method selected by the user of the UE, i.e., over a WLAN, over a private GSM or 3G network, or over a public network; (b) an access method automatically selected by the communication system; and/or (c) the identity or subscriber profile of the calling or called party, or either a public network, a private network, or a combination of a private and public network; and

(xiv) ability to build or provide location based services.

### BRIEF DESCRIPTION OF THE FIGURES

These and various other features and advantages of the present invention will be apparent upon reading of the following detailed description in conjunction with the accompanying drawings, where:

FIG. 1 is a block diagram of a communication system according to an embodiment of the present invention having a private network including a wireless local area network (WLAN) coupled to a private cellular network and a private branch exchange, and a public network having a public global system for mobile communications (GSM) network and a public third-generation mobile communications (3G) network;

FIG. 2 is a block diagram of a communication system including a HiperLAN, HiperMAN, and 802.11 WLANs coupled to a private cellular network and a public network, and a Remote Authentication Dial In User Service (RADIUS) server coupling the WLAN to public and private home location registries (HLRs) according to an embodiment of the present invention;

FIG. 3 is a block diagram of a portion of the communication system of FIG. 2 illustrating the coupling of the RADIUS server to an access point, a user equipment terminal (UE), and the private HLR, according to an embodiment of the present invention;

FIG. 4 is a block diagram of a communication system including an 802.11 WLAN coupled to a private cellular network and a public network, and a RADIUS server according to an embodiment of the present invention;

FIG. 5 is a flowchart showing an embodiment of a process for enabling UEs to communicate with a private cellular network and a public network via a WLAN according to an embodiment of the present invention;

FIG. 6 is a block diagram of a communication system including a corporate LAN coupled to the public network through a WLAN according to an embodiment of the present invention;

FIG. 7 is a block diagram of an alternative embodiment of the communication system of FIG. 6, having multiple RADIUS servers, authentication servers and clients according to the present invention;

FIG. 8 is a block diagram of an embodiment of a communication system having distributed private HLR and authentication server according to the present invention for enabling roaming of UEs;

FIG. 9 is a block diagram of yet another embodiment of a communication system including multiple corporate LANs according to the present invention;

FIG. 10 is a block diagram showing communication routing in a communication system including a WLAN and a RADIUS server according to the present invention; and

FIG. 11 is a block diagram showing an embodiment of architecture of a communication system according to the present invention.

### DETAILED DESCRIPTION

The present invention is directed to a communication system and method for enabling user equipment terminals (UEs) associated with a wireless local area network (WLAN) to communicate with a public network.

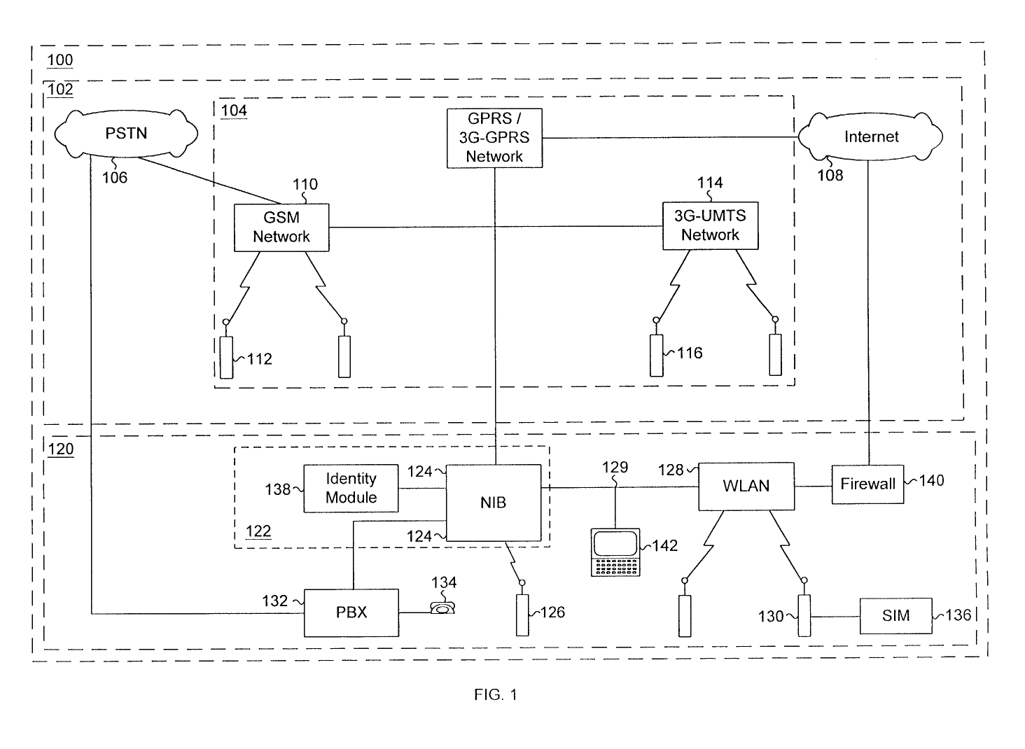

A communication system according to the present invention will now be described with reference to FIG. 1. FIG. 1 is an exemplary block diagram of a communication system having a WLAN coupled to a public network including a global system for mobile communications (GSM) network and a third-generation mobile communications (3G) network according to an embodiment of the present invention. For purposes of clarity, many of the details of communication systems and in particular of GSM networks and 3G-networks that are widely known and are not relevant to the present invention have been omitted.

Referring to FIG. 1, the communication system 100 generally comprises a public core network or public network 102 including a public cellular network 104 with connections to a public switched telephone network (PSTN 106) and the Internet 108. The public cellular network 104 can include a GSM 110 network for communicating with public mobile stations (MSs 112) and a 3G-network 114, such as a 3G-UMTS (universal mobile telecommunications system), for communicating with public UEs 116. The public cellular network 104 typically further includes a general packet radio service network (GPRS)/3G-GPRS network 118.

The communication system 100 further includes a private network 120 with a private cellular network 122 for communicating with private MS 126, a WLAN 128 for communicating with private transceivers or UEs 130, and, optionally, a private branch exchange (PBX 132) for communicating with PBX telephones 134. In one embodiment, the private cellular network 122 includes at least one WAVEXchange™ (WXC) or a Network-In-A-Box™ (NIB 124) commercially available from interWAVE Communications Inc., of Menlo Park, Calif. A WXC generally includes a mobile services switching centers (MSC), a built-in Visitor Location Registry (VLR)/Home Location Registry (HLR). The NIB 124 includes a MSC, a Base Station Controller (BSC) and a Base Transceiver Station (BTS) in a single enclosure. The private cellular network 120 is coupled to the GSM network 110, the GPRS network 118, and the 3G-network 114 of the public cellular network 104 through a number or interface functions or links, described in more detail below.

In accordance with the present invention, the WLAN 128 is coupled to the public network 102 through the NIB 124 and is adapted to enable voice and data communication between the private UEs 130 and the private mobile stations 126, public mobile stations 112, public UEs 116, PBX telephones 134, and telephones (not shown) coupled to the PSTN 106 and/or the Internet 108. Access points (not shown in this figure) of the WLAN 128 can be coupled to the NIB 124 through a wired local area network (LAN 129), such as an Ethernet, 100Base T, Fast Ethernet or Gigabit Ethernet, or through a wireless or radio-link (not shown). One advantage of the communication system 100 of the present invention is the ability to enable communication between the public network 102 and less expensive, low-power, unregulated private UEs 130 while providing substantially the same functions and services available from much more expensive radios, MSs 112 or UEs 116 of the public cellular network 104 and/or private cellular network 122.

It will be understood, that the communication system 100 can include a number of private cellular networks 122, each with an associated WLAN 128, and each linked by a private wide area network (PWAN) (not shown) to provide wireless or cellular type communication via a WLAN over an extended service area. This embodiment provides the further advantages of the ability to avoid tolls and maintain ownership and control of information transmitted between different sites of an enterprise linked by the PWAN.

In another embodiment, the private UE 130 further includes coupled thereto a subscriber identity module (SIM 136) having an algorithm and a key to support authentication and encryption necessary to enable or facilitate communication with the public network. 102 and/or private cellular network 124. In one version of this embodiment, each private UE 130 includes a card holder/reader (not shown in this figure) and one or more GSM-type SIM cards or 3G-type USIM cards (not shown) held in the card holder/reader, each SIM card subscriber identification and security information stored therein for one or more user profiles, which may include public network or private network subscription identifiers, or a combination of both public and private subscription data/identifiers. Alternatively, the SIM 136 encompasses subscriber identification and security information stored in a memory system (not shown) of the private UE 130. This latter version has the advantage of enabling the SIM 136 to be downloaded from the WLAN 128 along with computer software or programs that enable the private UE 130 to emulate or function as a communication terminal. Such emulator programs are described in greater detail in commonly assigned, co-pending U.S. Provisional Application Serial No. ______,(attorney docket no. A-71405/MSS/WEN) entitled TerminalDevice Emulator, filed Mar. 18, 2002, which is incorporated herein by reference.

In yet another embodiment, the private network 120 further includes an identity module 138 coupled to the NIB 124, and having at least one identifier or virtual identifier stored therein that can be permanently or temporarily associated with one or more private UEs 130, to enable the private UE to communicate with the public network 102 and/or the private cellular network 122 via the WLAN 128. Identity modules and virtual identifiers and described in greater detail in commonly assigned, co-pending U.S. patent application Ser. No. 10/002,551, filed Nov. 1, 2001, which is incorporated herein by reference. Generally, the virtual identifiers include algorithms and a key to support authentication and encryption necessary to facilitate communication with the public network 102 or private cellular network 122. In one version of this embodiment, the identity module 138 includes subscriber identification and security information stored in a memory system (not shown) coupled to the NIB 124. Alternatively, the identity module 138 includes a card holder/reader (not shown), as described above, and the virtual identifiers include one or more GSM-type SIM cards or 3G-type USIM cards held in the card holder/reader), as described above.

The virtual identifiers can be associated with the private UEs 130 on a one-to-one basis; on a one-to-many basis; or on a many-to-many basis in which the virtual identifiers are maintained as a pool of virtual identifiers that are associated temporarily with a private UE on an as needed basis. Alternatively, the virtual identifiers can be associated with the private UEs 130 on a many-to-one basis to provide a single private UE with multiple different user profiles that can be selected by a user for record or billing purposes. For example, a user placing a call from a private UE 130 over the public cellular network 104 could enter a first code selecting a first user profile when the call is for business purposes, and a second when the call is for private purposes. In addition, the communication system 100 or the user can select a GSM-type subscriber identity module (SIM) identifier (virtual SIM) when the communication is over the GSM network 110, and a 3G-type USIM identifier (virtual USIM) when it is connected or routed over the 3G network 114.

Preferably, the SIM 134 or identity module 138, and programs or software in the private UE 130 that allow it to emulate a communication terminal, are also adapted to enable the private UE to control or access supplementary and/or value added services provided by the private cellular network 122 or public network 102 service provider. Supplementary services can include, for example, Voice Group Call Service; Voice Broadcast Service; Service definition Line Identification Supplementary Services; Call Forwarding Supplementary Services; Call Waiting and Call Hold Supplementary Services; multiparty Supplementary Services including call conferencing; Closed User Group Supplementary Services, Advice of Charge Supplementary Services; Call Barring Supplementary Services; Unstructured Supplementary Service Data; Explicit Call Transfer; Completion of Calls to Busy Subscriber; Short Message Service; and Follow Me. Value added services include, for example, e-mail, calender, and wireless inventory, etcetera.

The WLAN 128 can include one or more separate and discrete networks each using one of a number of different protocols including IEEE 802.11 standards (802.11), and the European Telecommunications Standards Institute (ETSI) standards for Broadband Radio Access Networks (BRAN), such as high performance local area networks (HiperLAN) and high performance metropolitan area networks (HiperMAN). These standards serve to ensure the interoperability of wireless communications equipment operating in the same spectrum but manufactured by different manufacturers. In particular, BRAN is a set of communication standards for Broadband Radio Access Networks developed by ETSI in response to growing market pressure for low-cost, high capacity radio link, and is used chiefly in European countries. BRAN provides broadband wireless access at a rate of 25 Mbit/s or more to networks or WLANs operating in either licensed or license exempt spectrum. IEEE 802.11 standards are a similar set of WLAN standards. There are two types of HiperLAN: (i) HiperLAN/1, which provides communications at up to about 20 Megabytes Per Second (Mbps) in the 5 GHz band; and (ii) HiperLAN/2, which provides communications at up to 54 Mbps in the same band. HiperMAN is a similar standard used for systems serving a metropolitan area. Although, HiperMAN is generally used in larger communication systems that could be defined as a wireless metropolitan area network, rather than a WLAN, it will be appreciated that the principles of the present invention can be applied to such a communication system. Accordingly, it will be understood that as used herein the term WLAN refers to both wireless local area networks and a wireless metropolitan area networks. IEEE 802.11 refers to a line of related specifications or standards developed by the IEEE for wireless communication, including 802.11, 802.11a, 802.11b, 802.11g and 802.11x. 802.11 is similar to HiperLAN and applies to WLANs having from 1 or 2 Mbps transmission rates in the 2.4 GHz band using either frequency hopping spread spectrum (FHSS) or direct sequence spread spectrum (DSSS). 802.11a is an extension to 802.11 that applies to WLANs, provides up to 54 Mbps in the 5 GHz band, and uses an orthogonal frequency division multiplexing encoding scheme rather than FHSS or DSSS. 802.11b, also known as 802.11 High Rate or WiFi, is another extension that provides up to 11 Mbps transmission rates in the 2.4 GHz band, allowing wireless functionality comparable to Ethernet. Thus, 802.11b is particularly useful interfacing with or coupling to GPRS systems according to the present invention for wireless transmission of data. 802.11g applies to WLANs and provides greater than 20 Mbps in the 2.4 GHz band.

In still another embodiment, the WLAN 128 is further coupled to the Internet 108 through a firewall 140, to enable the private UE 130 to transfer video and audio data, and/or to transfer or download large files or attachments to or from other data processing systems or servers. Preferably, the private UE 130 is adapted to enable a user to simultaneously carry on communication, for example voice communication, with a telephone or terminal in the private cellular network 122 or public network 102, and communication, for example data communication, with a terminal coupled to the Internet 108. More preferably, the private UE 130 includes a computer program to simultaneously enable voice over an internet protocol network communication (VoIP), with a telephone or terminal (not shown) coupled to the Internet 108, WLAN 128, LAN 129 or another IP network. The VolP program can include a standard VoIP program native to the private UE 130, which comes standard on many computers and portable computers, or a VolP program included with computer software or programs downloaded from the WLAN 128, such as the virtual SIM or emulator program, as described above.

In still another embodiment, computers or terminals 142 coupled to the NIB 124, through the LAN 129, are also adapted to communicate voice and data with telephones or terminals in the public cellular network 104 and/or private cellular network 122 via the NIB 124 and the interface functions or links from the NIB to the public and private cellular networks 104, 122.

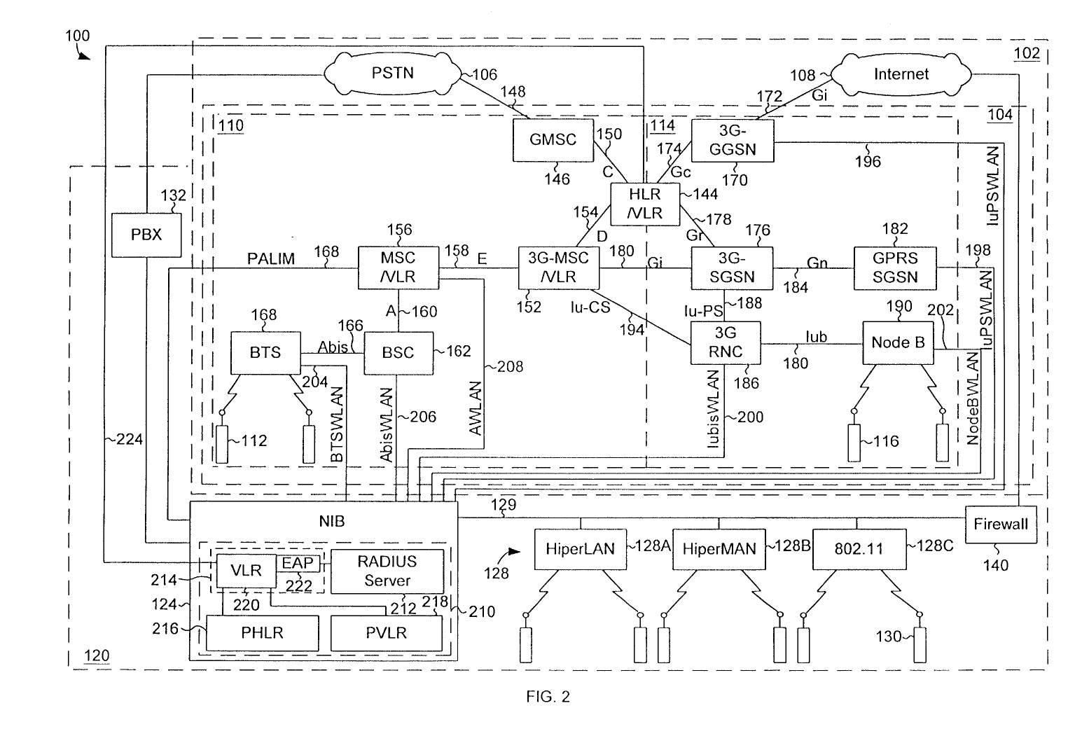

An embodiment of the communication system 100 of the present invention will now be described in greater detail with reference to FIG. 2. Referring to FIG. 2, the public network 102 includes a public home location registry (HLR)/visitor location registry (VLR) 144 coupled to the GSM network 110 and the 3G-network 114. The public HLR of the HLR/VLR 144, can include, for example, a home location register and/or a home subscription sever (HSS), and records and stores information relating to users or subscribers of the public network. The VLR of the HLR/VLR 144 maintains subscriber information for visitors or roamers to the cells or area served by the public cellular network 104. Generally, the HLR/VLR 144 also includes an authentication and accounting server or function (not shown) used by many service providers to authorize access to the public GSM network 110 and/or the public 3G-network 114.

The GSM network 110 includes a gateway mobile services switching center (GMSC 146) coupled to the PSTN 106 through a landline or trunk 148, and to the HLR/VLR 144 through a C interface or link 150. The GMSC 146 is a gateway switching center or exchange that directs or routes calls from the PSTN 106 to the MSs 112, and from the MS to the PSTN. A third generation mobile services switching center (3G-MSC 152) coupled to the HLR 144 through a D interface or link 154 provides switching services and co-ordination between mobile stations 112 in the GSM network 110 and public UEs 116 in the 3G network 114. Optionally, the 3G-MSC 152 also include another or second VLR to maintain subscriber information for visitors or roamers to the cells or area served by the 3G-MSC. The 3G-MSC 152 also couples to one or more MSCs 156, only one of which is shown, through an E interface or link 158. As with the 3G-MSC 152, the MSC 156 can also include a VLR to maintain subscriber information for visitors or roamers to the cell or area served by the MSC. The MSC 156 in turn couples through an A interface or link 160 to one or more base station controllers (BSC 162), each of which controls one or more base transceiver stations (BTS 164) through an Abis interface or link 166. The MSC 156 also couples to the private cellular network 122 through a private A-link intelligent multiplexor interface function or link (PALIM 168). PALIM functions or links are described detail in commonly assigned U.S. Pat. Nos. 5,818,824, 5,734, 699, 5,999,813 and 6,212,395, all of which are incorporated herein by reference.

In the embodiment shown, the 3G-network 114 includes a third-generation gateway general packet radio service (GPRS) support node (3G-GGSN 170) coupled to the Internet 108 through a Gi interface or link 172, and to the HLR 144 through a Gc interface or link 174. The 3G-GGSN 170 provides an interface between the 3G cellular network 114 and an IP network, such as the Internet 108. A third generation serving GPRS support node (3G-SGSN 176) coupled to the HLR 144 through a Gr interface or link 178 and to the 3G-MSC 152 through a Gi link 180, handles data traffic in an area served by the 3G cellular network 114. Optionally, the 3G-SGSN 176 is further coupled to a local, second generation (2G) or GPRS SGSN 182 through a Gn interface or link 184 to provide an interface between the 3G cellular network 114 and the WLAN 128. The 3G-SGSN 176 also couples to one or more 3G radio network controllers (3G RNC 186), only one of which is shown, through an Iu-PS interface or link 188. Each 3G-RNC 1864 controls one or more Node Bs 190 through an Iub interface or link 192. The 3G-RNC 186 also couples to the 3G-MSC 152 through an Iu-CS interface or link 194 to provide communication between the public UEs 116 and the MSs 112 of the GSM network 110 or telephones (not shown) connected to the PSTN 106.

As shown in FIG. 2, and as noted above, the WLAN 128 can include one or more separate and discrete networks or access points 128A, 128B, 128C, each using a number of different protocols including HiperLAN, HiperMAN and 802.11, as described above. The particular network or protocol used in the WLAN 128 can be selected based on factors including cost, desired bandwidth or bit-rate, or required range, frequency and regulatory limitations. For example, a communication system 100 in Europe or other states or nations adopting the HiperLAN standards might use the HiperLAN/1 or HiperLAN/2 standard depending on the desired bit-rate, while systems in the United States might use one of the 802.11 standards. Communication systems 100 serving a metropolitan area or requiring a higher capacity or bandwidth might use the HiperMAN standard.

As also shown in FIG. 2, the WLAN 128 can be coupled to the Internet 108 and to a number of different components in the GSM network 110 and/or the 3G-network 114. For example, in the 3G-network 114 the WLAN 128 can be coupled to the 3G-GGSN 170 through the NIB 124 and via an IuPSWLAN interface or link 196, the GPRS SGSN 182 via an IuPSWLAN interface or link 198, the 3G-RNC 186 via an IubisWLAN interface or link 200, and/or to one or more Node Bs 190 via a NodeBWLAN interface or link 202. In the GSM network 110 the WLAN 128 can be coupled to the BTS 168 via a BTSWLAN interface or link 204, to the BSC 162 via an AbisWLAN interface or link 206, and/or to the MSC 156 via an AWLAN interface or link 208. In addition, the WLAN 128 can be coupled to the MSC 156 through the NIB 124 and over the PALIM link 168, described above.

It will be understood that where the WLAN 128 includes multiple separate networks or access points 128A, 128B, 128C, which may or may not use different protocols, each of the separate access points can be coupled through the NIB 124 to different components in the public network 102. For example, it might be desirable to couple an access point 128C using an 802.11b standard for high speed transmission of data to the GPRS SGSN 182.

In yet another embodiment, the communication system 100 further includes a Remote Authentication Dial In User Service (RADIUS) system 210, having a RADIUS authentication and accounting gateway or server 212. The RADIUS system can be combined with the NIB 124, as shown, or can comprise a standalone RADIUS server 212 separate and distinct from the NIB. RADIUS is an authentication and accounting system used by many service providers to authorize access to a communication system. Though not an official standard, the RADIUS specification is maintained by a working group of the Internet Engineering Task Force (IETF). Generally, RADIUS requires users to enter a username and password, which is passed to the RADIUS server 212 to check that the information is correct, and authorize access to the communication system 100. A separate authentication/authorization server (not shown in this figure) within the RADIUS system 210 or coupled to the RADIUS server 212 provides or supports roaming capabilities for the private UEs 130 among the plurality of access points 128A, 128B, 128C and the public cellular network 104. Additionally, the RADIUS server 212 receives accounting packets or call detail records (CDRs) generated by the different access points 128A, 128B, 128C, and forwards these accounting packets to a billing server (not shown) through a RADIUS proxy interface (not shown) to bill telecommunications charges to the appropriate parties.

Preferably, the RADIUS server 212 is coupled via a VRAD 214 to the public HLR/VLR 144 and to a private HLR (PHLR 216) and/or private VLR (PVLR 218). The VRAD 214, private HLR 216 and private VLR 218 can be combined with the RADIUS system 210, as shown, or can comprise a standalone server separate and distinct from the RADIUS system. For example the VRAD 214, private HLR 216 and private VLR 218 can be combined with the NIB 124, and the system 210 or server 212 can be separate and distinct from the NIB 124, as described above. The private HLR 216 is stores information on UEs 130 registered or subscribing to the communication system 100, and more particularly to the WLAN 128 and/or the private cellular network 122. The private VLR 218 is capable of temporarily storing information on subscribers or UEs 130 considered as roaming within the service area of the WLAN 128. The VRAD 214 is a VLR-RADIUS interface, and includes an internal integral VLR 220 and an extensible authentication protocol (EAP) interface 222 for signaling to the public HLR/VLR 144 and the private HLR 216. The RADIUS server 212 couples to the public HLR/VLR 144 via an EAP over RADIUS link (EAP/RADIUS Link 224). The RADIUS server 212 further couples to the public HLR/VLR 144 via the LAN 129 and the Internet 108 over an EAP over SIM link (not shown in this figure) for transmission of data. The RADIUS server 212 couples to one or more access points 128A, 128B, 128C, via the NIB 124 and the LAN 129.

The RADIUS server 212 supports roaming of private UEs 130 based on a RADIUS/DIAMETER roaming model along with traditional GSM subscriber roaming based upon the mobile application part (MAP) standard for address registration of roamers and inter-system hand-off procedures. In case of a communication system 100 having a number of private cellular networks 122, each with an associated WLAN 128 and linked by a PWAN (not shown), the RADIUS server 212 can act as a proxy to forward an authentication request via the VRAD 214 to a single, central public HLR/VLR 144 and/or a single, central private HLR 216 Alternatively, where the communication system 100 includes either a distributed public HLR/VLR 144 and/or a distributed private HLR 216, the RADIUS server 212 routes an interpretation of either a username or a user identity provided in the authentication procedure, to the appropriate public or private HLR. In one version of this embodiment, the RADIUS server 212 is enhanced to contact the appropriate or controlling public or private HLR 144, 214, either by: (i) querying a standalone Central Address Table server (not shown) coupled thereto to match International Mobile Subscriber Identity (IMSI) information provided in the authentication procedure to the corresponding HLR; or (ii) using a configuration table that matches the IMSI ranges with the appropriate or controlling public or private HLR. This last model works well if IMSI partitioning is implicitly or explicitly enabled for subscriber provisioning across multiple public or private HLR 144, 216.

Moreover, because the location of the private UEs 130 become known in the RADIUS server 212 and/or the VLR 220 during the authentication or registration process, the communication system 100 of the present invention has the ability to build or provide services based on location or location based services.

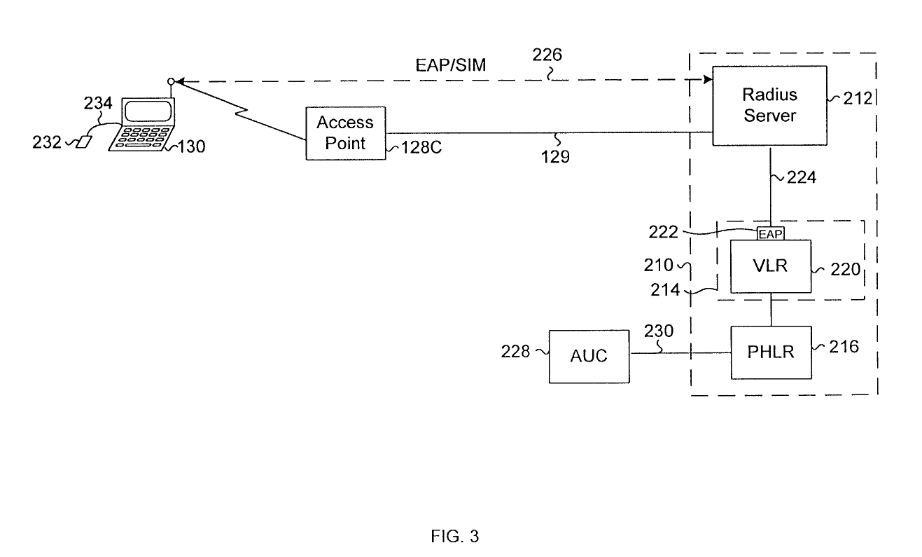

Coupling between the private UEs 130 and the RADIUS server 212, and between the RADIUS server and the public or private HLR 144, 216, can be seen more clearly in FIG. 3. Referring to FIG. 3, the access point 128C couples to the RADIUS server 212 via the LAN 129 or via a separate radio link (not shown) and via an EAP/SIM Link 226, and to the private HLR 216 via EAP/RADIUS link 224. In an alternative to the embodiment shown in FIG. 2, the authentication/authorization can be handled by a separate authentication/authorization server 228 coupled to the private HLR 216 via a proprietary link 230, as shown. As indicated previously and as shown in FIG. 3, the private UE 130 must provide authentication information in a manner similar to a GSM MS 112. Generally, this there are three different ways or methods of accomplishing this, including: (i) use of a universal serial bus (USB) adapter 232 that enables the private UE 130 to communicate with a GSM-type SIM card or a 3G-type USIM card via a USB bus 234; (ii) use of a PCMCIA adapter (not shown) that enables the private UE 130 to communicate directly with a GSM-type SIM card; or (iii) use of a virtual SIM as described briefly above and in greater detail in U.S. patent application Ser. No. 10/002,551.

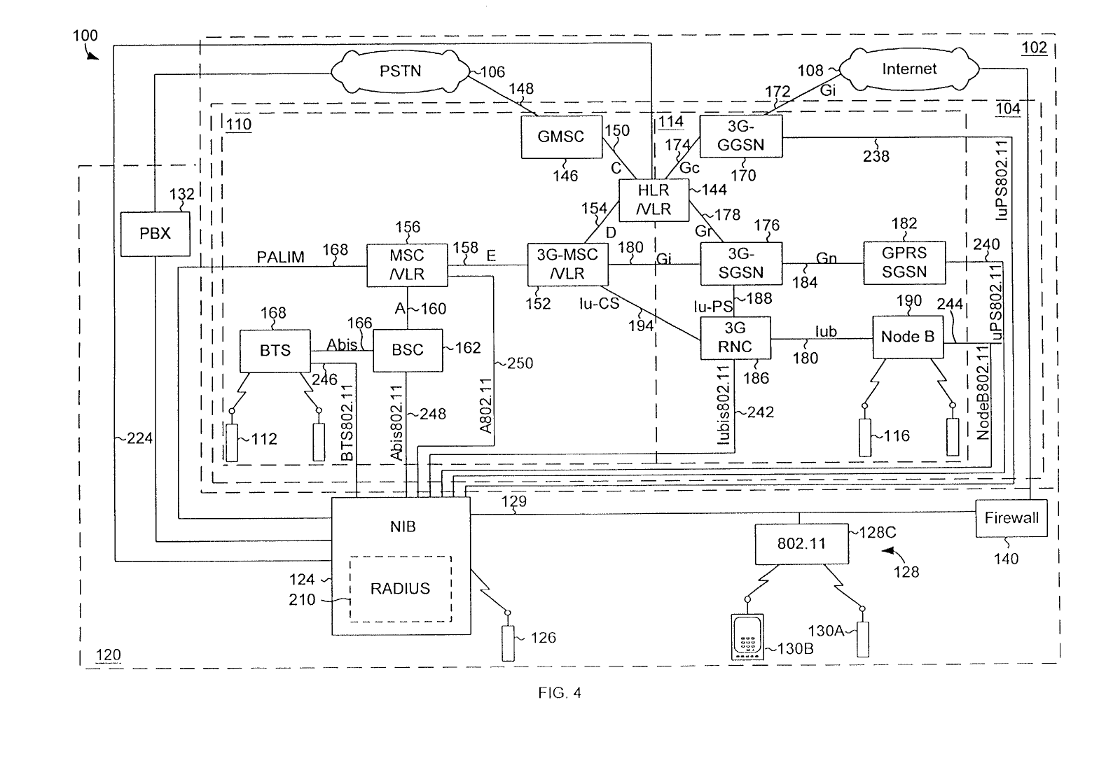

A preferred embodiment in which the WLAN 128 includes an 802.11 network will now be described with reference to FIG. 4. Referring to FIG. 4, the public cellular network 104 includes a GSM network 110 and a 3G-network 114, as described above. The WLAN 128 includes an 802.11 network having one or more 802.11 access points 236 (only one of which is shown), and adapted in accordance with the present invention to couple communication between the private UEs 130 and the public network 102 and/or private cellular network 122. The private UEs 130 can include voice communication devices 130A, such as wireless telephones or mobile stations, and data communication devices 130C, such as pagers, facsimile machines, portable computers, network access appliances and personal digital assistants (PDAs).

In the 3G-network 114 the 802.11 access point 128C is coupled to the 3G-GGSN 170 through the NIB 124 and via an IuPS802.11 interface or link 238, the GPRS SGSN 182 through the NIB and via an IuPS802.11 interface or link 240, the 3G-RNC 186 through the NIB 124 and via an Iubis802.11 interface or link 242, and/or to one or more Node Bs 190 through the NIB 124 and via a NodeB802.11 interface or link 244 In the GSM network 110 the 802.11 access point 128C can be coupled to the BTS 168 through the NIB 124 and via a BTS802.11 interface or link 246, to the BSC 162 through the NIB 124 and via an Abis802.11 interface or link 248, and/or to the MSC 156 through the NIB 124 and via an A802.11 interface or link 250 In addition, the WLAN 128 can be coupled to the MSC 156 through the NIB 124 and over the PALIM link 168, described above.

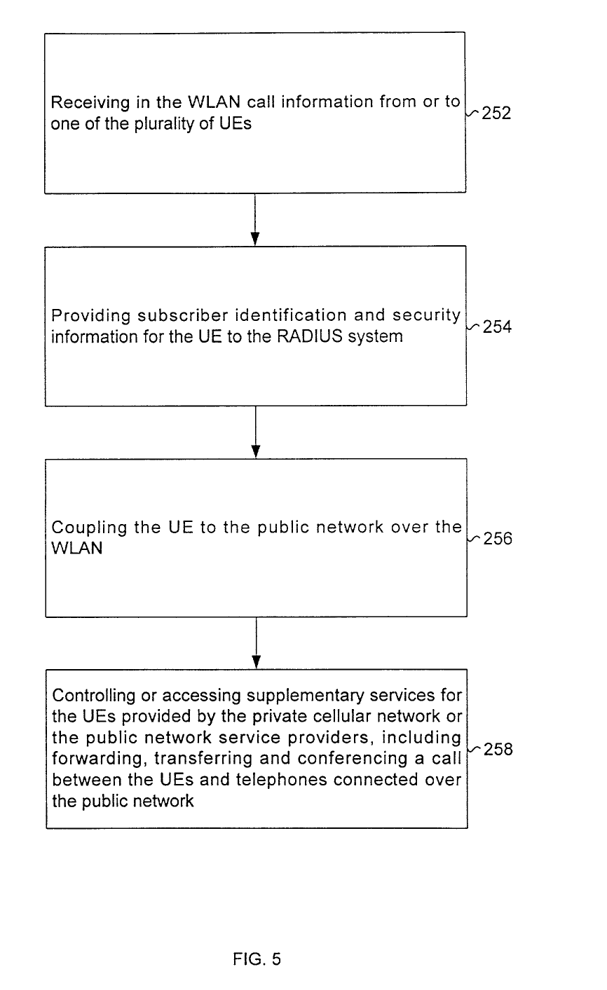

A method or process for operating communication system 100 according to an embodiment of the present invention will now be described with reference to FIG. 5. FIG. 5 is a flowchart showing steps of a method for facilitating communication between private UEs 130 and the public network 102 via a WLAN 128. In the method, call information from or to one of a number of private UEs 130 is received in the WLAN 128 (step 252). Subscriber identification and security information for the private UE 130 is provided to the RADIUS system 210 (step 254), and the private UE is coupled to the public network over the WLAN (step 256). In one preferred embodiment, the communication between the private UEs 130 and the public network 102 is voice communication, and the method further includes the step of controlling or accessing supplementary services for the UE provided by the private cellular network 122 or public network 102 service provider (step 258).

As noted above, the subscriber identification and security information can be provided from a 3G-type USIM or GSM-type SIM 136 associated with each private UE 130, or from an identity module 138 in the private cellular network 122. Moreover, where the identity module 138 of the communication system 100 includes a memory system (not shown) having subscriber identification and security information stored therein, and the step of providing subscriber identification and security information for the private UE 130 to the RADIUS system 210, step 254, is accomplished by providing subscriber identification and security information associated with the private UE from the memory system. Alternatively, where the communication system 100 further includes a card holder/reader holding a number of cards associated with the private UEs 132, and step 230 involves reading subscriber identification and security information stored in one of the number of cards held in the card holder/reader.

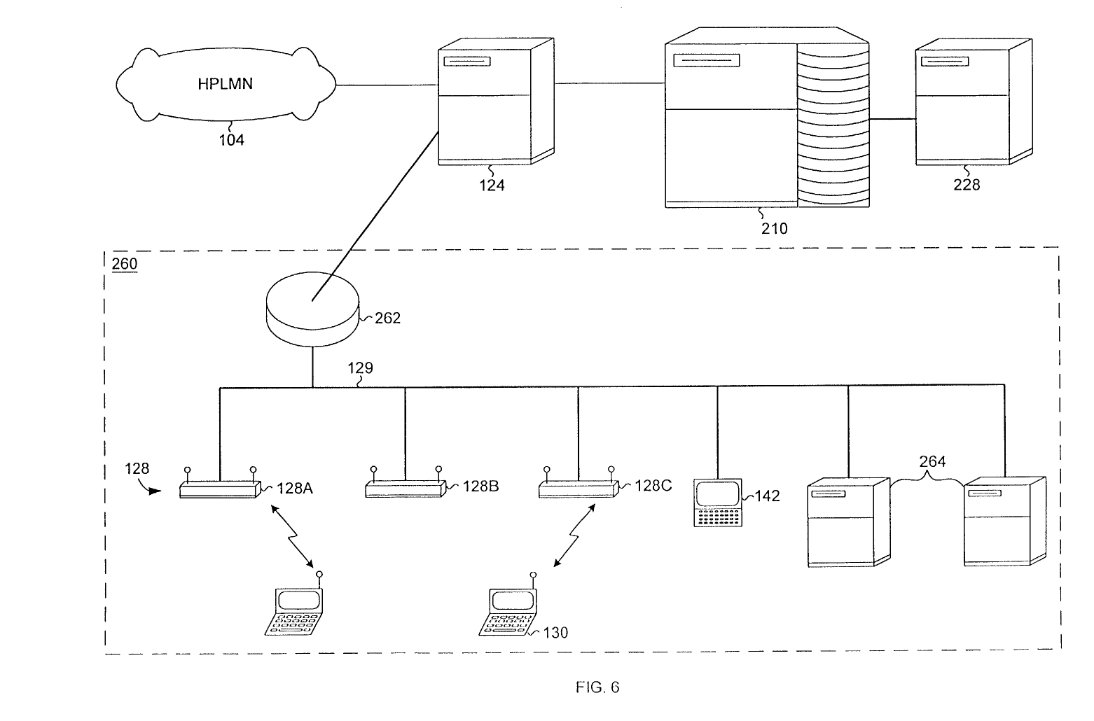

Certain exemplary embodiments of a communication system according to the present invention, their uses and advantages will now be described with reference to FIGS. 6 to 12.

FIG. 6 is a block diagram of an embodiment of a communication system 100 having a private corporate LAN 260 including a WLAN 128 according to the present invention, coupled to a public cellular network 104, such as a home public land mobile network (HPLMN), a RADIUS system 210 and an authentication server 228. Generally in this embodiment, the corporate LAN 260 includes, in addition to the WLAN 128, a hub or router 262 coupled through a wired LAN 129 to a number of access points 128A, 128B, 128C, in the WLAN and to other terminals, such as computer terminals 142 or servers 264. As described above, the RADIUS system 210 includes a RADIUS server or gateway for authorizing access to the communication system 100, and a private HLR (not shown in this figure). The authentication server 228 provides or supports roaming capabilities for the private UEs 130 among the plurality of access points 128A, 128B, 128C and the public cellular network 104. The RADIUS system 210 communicates with the authentication server 228 to obtain user credentials and a ciphering key to enable true GSM-type authentication. Preferably, o provide sufficient level of security in the communication system 100 the authentication server 228 uses a GSM A3/A8 algorithm for key generation.

In accordance with the present invention, users of UEs 130 can access data in the servers 264, while simultaneously communicating with one another or with other terminals or telephones coupled to the public cellular network 104. This embodiment provides a central private HLR (not shown in this figure) in the RADIUS system 210 to centralize operation and management (OAM) functions, and to minimize the changes necessary to the WLAN 128 to access or control supplementary or value added services and communication with the public cellular network 104 for the private UEs 130. Preferably, the private HLR is able to handle or serve at least about 100,000 mobile stations, UEs 130 or users, and the authentication server 228 at least about 200,000, making this embodiment particularly suitable for use in airports, hotels, convention centers, etcetera.

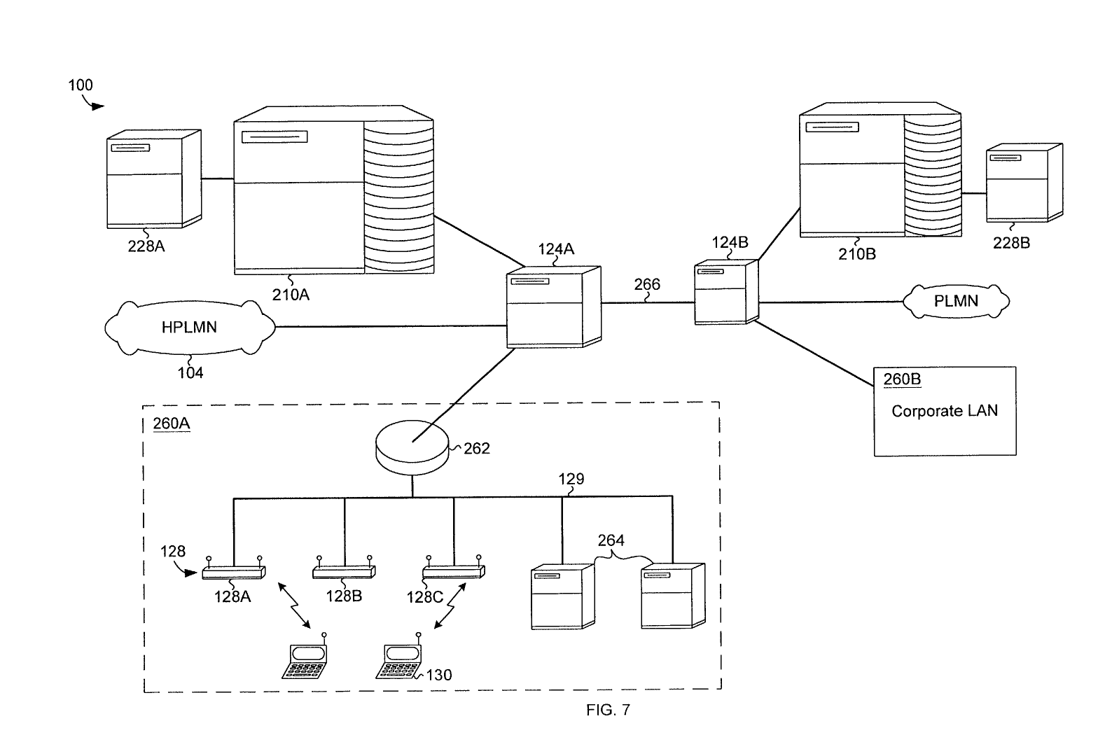

FIG. 7 is a block diagram of an alternative embodiment of the communication system of FIG. 6, having a number of RADIUS systems 210A, 210B or private HLRs and authentication servers 228A, 228B, and NIBs 124A, 124B, linked by a PWAN 266 for distributing HLR registration and authentication loads. This embodiment is particularly suitable for use in enterprises operating a number of different WLANs 128 or corporate LANs 260A, 260B, at a number of different sites. For example, a chain of hotels, recreational parks or business centers owned and/or operated by a single enterprise.

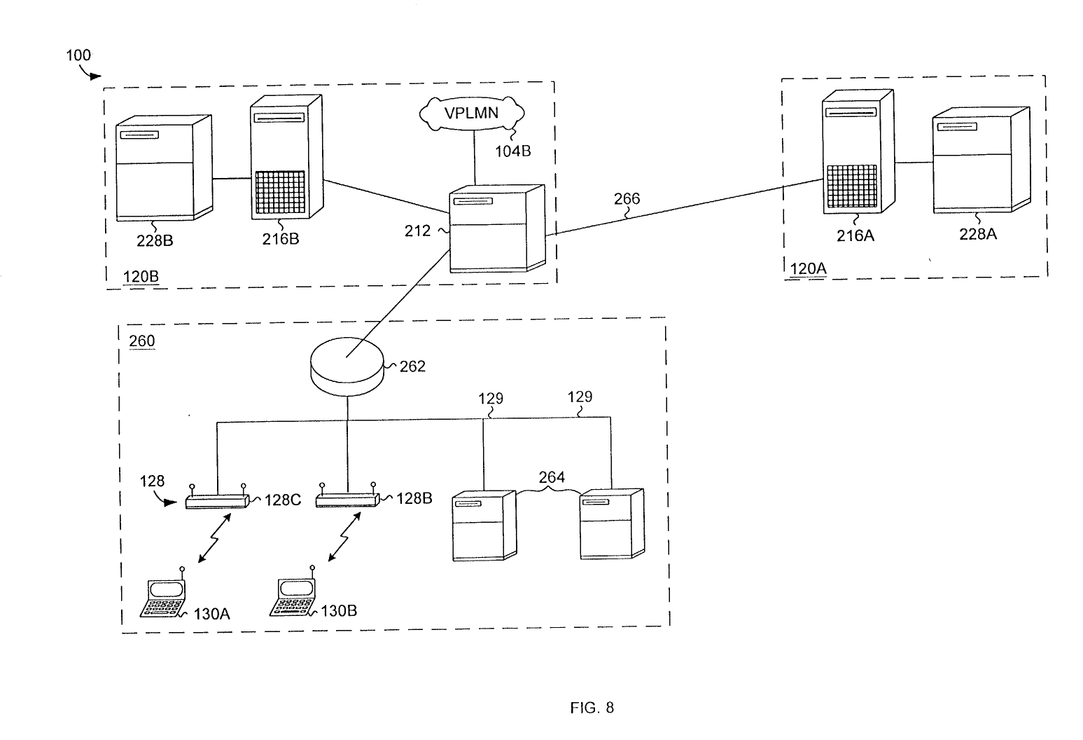

FIG. 8 is a block diagram of yet another alternative embodiment of the communication system of FIG. 6, illustrating roaming of 802.11 or GPRS enabled UEs 130 between a coupled to a home private network 120B, and a visited private network 120B coupled to a visited public cellular network 104B or visited public land mobile network (VPLMN). Referring to FIG. 8, a visiting private UE 130A to an area served by the corporate LAN 260 is able to communicate with another UE 130B home private network 120A and terminals or servers 264 in the corporate LAN 260 and with terminals in the public network 102 through the local or visited public cellular network 104B and the corporate LAN. To authenticate the UE 130A and authorize access to the communication system 100, RADIUS messages are passed from the visiting UE 130A through the router 260 to a NIB (not shown in this figure) or a RADIUS gateway or server 212 in the visited private network 120B. The RADIUS server 212 determines subscriber information for the visiting UE 130A is not stored in private HLR 216B but in a private HLR 216A in the home private network 120A. RADIUS messages are then passed from the RADIUS server 212 over the PWAN 266 to the private HLR 216A and an authentication server 228A in the home private network 120A of the visiting UE 130A. Note, in this embodiment each of the distributed private HLRs 216A, 216B, can be smaller, and able to handle fewer mobile stations, UEs 130 or users than the HLR in the embodiments described above.

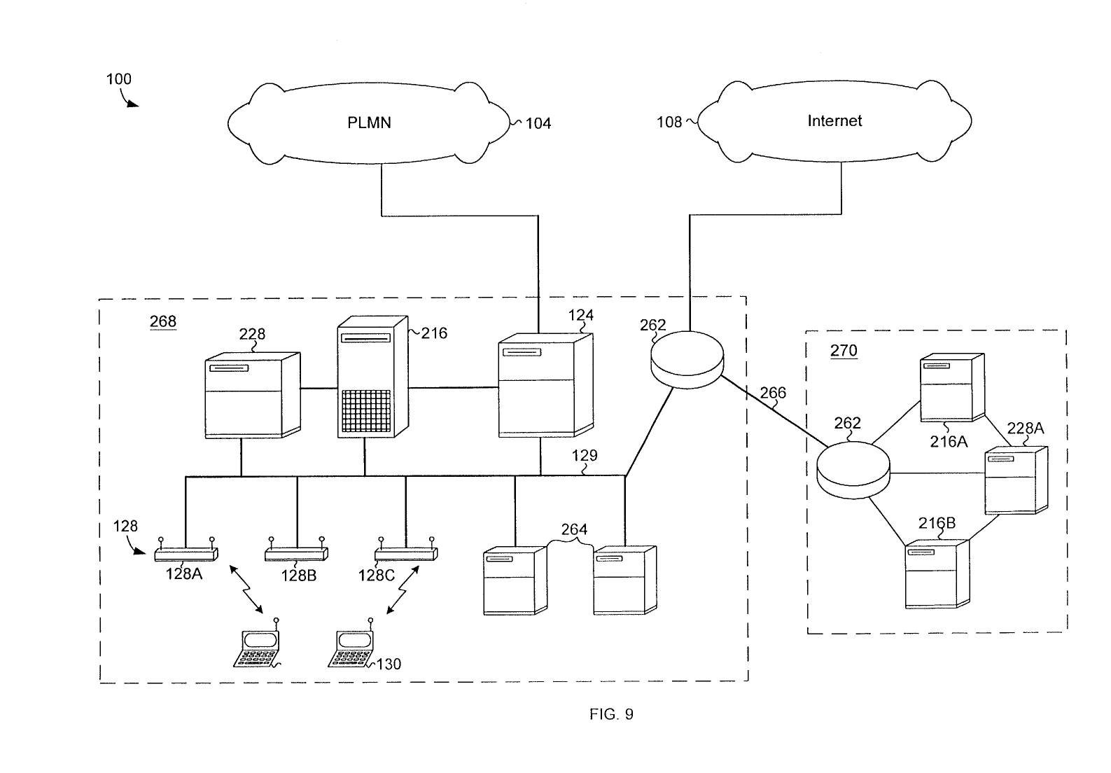

FIG. 9 is a block diagram of yet another embodiment of a communication system 100 according to the present invention, which is particularly suitable for use in airports, hotels, convention centers, etcetera. In this embodiment, a private network or corporate LAN 260 including a RADIUS server 212, a private HLR 216, an authentication server 228, a WLAN 128, and a LAN 129 coupling to servers 264 and access points 128A, 128B, 128C, of the WLAN are maintained at a first corporate site or location 268. The private network 120 at the first location 268 is coupled through a router 262 to the Internet 108 and, through a PWAN 266 to additional private HLRs 216A, 216B and authentication servers 228A, at additional corporate locations 270. This embodiment provides a distributed HLR and authentication servers, while centralizing OAM functions within the PWAN 266, and providing value added services for the private cellular network 122, and minimizing the changes necessary to the corporate LAN 260 to enable communication with the public cellular network (not shown in this figure). Preferably, each of the smaller distributed HLRs 216, 216A, 216B and authentication servers 228, 228A are able to handle or serve at least about 8,000 mobile stations, UEs 130 or users.

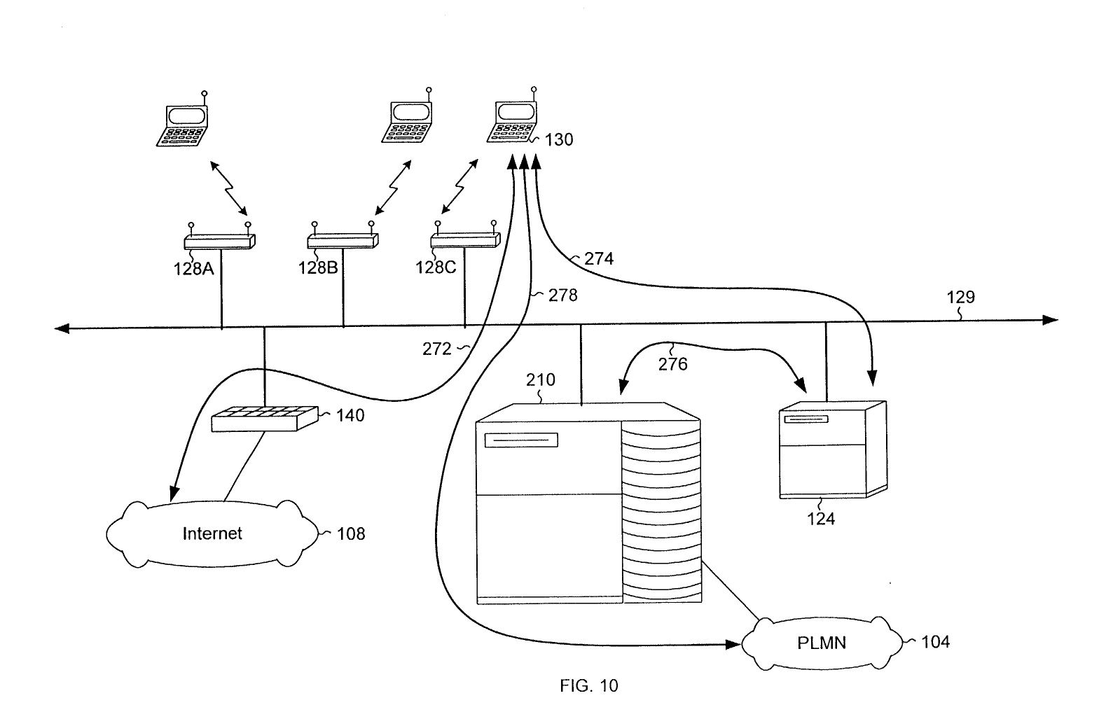

FIG. 10 is a block diagram showing communication routing in a communication system 100 including a WLAN 128 and RADIUS system according to the present invention. Referring to FIG. 10, arrow 272 shows the data path for user data from a UE 130 to an IP network, such as the Internet 108, through an access point 128C of the WLAN 128, LAN 129, and a firewall 140. In accordance with the present invention, the same or additional UEs 130 simultaneously couple to the public cellular network 104 or PLMN through the RADIUS system 210 as shown by arrows 274, 276, and 278. In particular, arrows 274 and 276 show a signaling path over which RADIUS messages are passed to identify the UE 130 and authorize access to the communication system 100. Arrow 278 shows the path of user data over which data, including voice, graphics or images, and other data is passed between the UE 130 and the public cellular network 104.

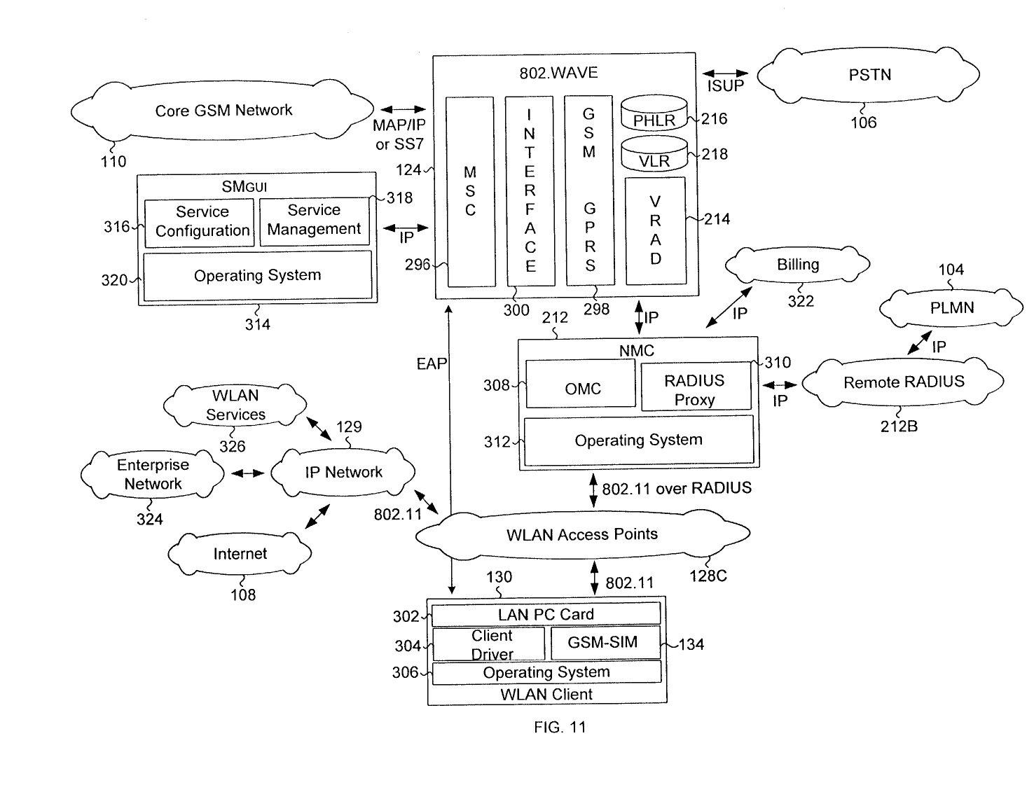

FIG. 11 is a block diagram of yet another embodiment of a communication system 100 showing an architecture of the communication system according to the present invention. Referring to FIG. 11 the core element of the communication system 100 is the NIB 124, which combines an MSC 296, a GSM/GPRS radio 298, a private HLR 216 and private VLR 218. The MSC 296 couples to the GSM/GPRS radio 298 through an interface 300, and to the private HLR 216 and private VLR 218 through a VRAD interface 222. The NIB 124 couples to a WLAN access points 128C through an EAP link, thereby enabling the NIB to full functional GSM/GPRS cellular capabilities as well as extending GSM/GPRS type security and roaming capabilities to UEs 130 over the WLAN 128. WLAN clients or UEs 130 capable of accessing the services provided through the NIB 124, generally include a LAN PC card 302 to enable wireless access, a GSM-type SIM 134, a client software or driver 304 to enable the UE to emulate a communication terminal and/or to control supplementary service provided by the communication system 100, and an underlying operating system 306.

The NIB 124 couples to a network management center (NMC) or RADIUS server 212 through the VRAD 222. In the embodiment shown, the RADIUS server 212 includes an operations maintenance center (OMC 308), RADIUS proxy function 310, and an underlying operating system 312. The RADIUS server 212 also couples to the WLAN access points 128C through an 802.11 over RADIUS link, thereby enabling the RADIUS server to authorize and control access to the communication system 100.

The NIB 124 also couples to a subscriber management graphical user interface (SMGUI 314) to allow management of the communication system 100 and the subscriber profiles maintained in the private HLR 216 and private VLR 218. The SMGUI 314 generally includes a service configuration function 316 for management of communication system configuration, a service management function 318 for management of subscriber profiles, and an underlying operating system 320.

The RADIUS server 212 couples via an IP network or link to other remote RADIUS servers 212B, and through the remote RADIUS servers to other GSM networks or PLMN 104. The RADIUS server 212 couples via an IP network or link to a billing server 322 or service. This particularly useful for forwarding billing information on roaming or visiting UEs 130.

The WLAN access points 128C are further coupled to an IP network, such as LAN 129, and through the LAN to the Internet 108, an enterprise network 324, and various WLAN services 326.

Some of the important aspects of the present invention will now be repeated to further emphasize their structure, function and advantages.

It will be appreciated that WLAN standards, such as IEEE 802.1X, HiperLAN/1 or HiperLAN/2, HiperMAN, and BRAN, can be used to derive authentication and encryption keys for use with any cipher, and can also be used to periodically refresh keys and re-authenticate so as to make sure that the keying material is fresh. These standards do not specify a single authentication method; rather they utilize Extensible Authentication Protocol (EAP) as its authentication framework. This allows WLAN enabled access points 128 to support a wide range of authentication methods, including certificate-based authentication, smartcards, token cards, one-time and passwords. Moreover, since switches and access points 128A, 128B, 128C, act as a pass-through for EAP, new authentication methods can be added without the need to upgrade the switch or access point, by adding software on the host and back-end authentication server 228.

A major advantage of using an WLAN based authentication scheme is that the access control capability is built into each access point 128A, 128B, 128C. An 802.11 enabled access point 128A, 128B, 128C, can directly communicate with a RADIUS system 210 or server 212 to authenticate a user or UE 130 and generate encryption key for the session. The access point 128A, 128B, 128C, can also store billing records for the subscriber and transfer them to the RADIUS system 210 using the RADIUS accounting protocol. The WLAN 128 based approach can be used to provide access to the Internet 108 in both wired LANs 129 as well as WLANs 128 operated by a service provider. Also, the client part of the network can be greatly simplified by using authentication functions for WLAN 128 based on WLANs built into many operating systems, such as the Windows XP® operating system, commercially available from Microsoft, Inc.

Another advantage of a communication system 100 according to the present invention is that the cellular service provider or service provider needs only to install a limited number of WLAN-enabled access points 128A, 128B, 128C, in the served areas, each access point directly communicating with a RADIUS system 210 or server 212. The use of EAP and WLAN-standards provides the required security in message exchange between the access point 128A, 128B, 128C, and the RADIUS system.

Yet another advantage is that EAP allows different authentication methods to be used by the authentication server 228 based upon configuration of the RADIUS system 210 and/or the authentication server. Thus, a cellular service provider can employ SIM based authentication to integrate 802.11 access information with a GSM user profile. A draft proposal outlining SIM based authentication using EAP, entitled EAP SIM authentication, is available from the Internet Engineering Task Force (IETF), and is incorporated herein by reference.

In one embodiment, an EAP interface 222 to a RADIUS server 212 is added to a VLR 220 in a NIB 124. This will allow authentication credentials to be exchanged between the WLAN 128 client UE 130 and a private HLR 216 following a GSM based authentication, encapsulated in EAP. The private HLR 216 will also be able to supply the access point 128A, 128B, 128C, with any user specific information, such as subscription profile, quality of service (QoS), etcetera, to enable any service differentiation.

In another embodiment, compact SIM card readers 232 which connect via a USB bus 234 to a UE 130, such as a personal computer (PC) or a laptop computer, can be used to support for SIM based authentication at client end. For example, an obtain/write interface layer between a WLAN driver of a Windows® based computer and the SIM card reader 232 allows authentication credentials to be generated and exchanged between the SIM and the access point 128A, 128B, 128C.

In still another embodiment, support for WLAN-session key generation can be accomplished using an algorithm similar to GSM ciphering key generation to ensure the WLAN solution offers a level of security close to that offered in GSM.

In yet another embodiment, inter-working capability between RADIUS based accounting and current GSM call data records or CDRs is accomplished by use of a separate accounting server (not shown). This accounting server receives the RADIUS accounting data from the access points 128A, 128B, 128C, converts the data into GSM based CDRs, for example, based upon subscriber profile, and transfers it to the billing entity using file transfer protocol (FTP).

In another embodiment, the communication system 100 according to the present invention has the ability to support roaming of WLAN 128 UEs 130 based upon a RADIUS/DIAMETER roaming model along with traditional GSM subscriber roaming based upon MAP. Requirements for different UEs 130, such as an 802.11 network access platform, include subscription to a WLAN service offered by a carrier. Generally, the user or subscriber would access the service provider's network through a WLAN enabled client device or UE 130, such as a laptop computer. Preferably, the client computer's operating system includes WLAN support, either natively or through additional drivers or an emulator program downloaded from the service provider, as described above. Two known operating systems satisfying this requirement are Microsoft Windows 2000® and Microsoft Windows XP®.

The UE 130 could authenticate in way similar to that of a GSM mobile station. There are several feasible methods of achieving this. In one method the UE 130 will need an authentication driver to interface with a GSM-type SIM card 134. This can be accomplished either through the use of a PCMCIA adapter or a USB adapter 232 that provides the ability for the UE 130 to communicate with the GSM-Type SIM card 134. A USB adapter 232 being more compact and reasonably priced than the PCMCIA adapter, it is the preferred interface. To emulate GSM authentication on the WLAN security framework, an EAP extension module or interface 222 is required. The EAP interface 222 will communicate with GSM-type SIM card 134 using an application programming interface (API), such as a PC Smartcard (PC/SC) interface, obtained from the service provider and plugged into the UE 130 as a dynamic linked library file (DLL).

The generation and use of session key for encryption of WLAN packets in conventional WLANs generally follows vendor specific interfaces. Thus, session key for encryption of WLAN packets depend on vendor specifications. In a preferred embodiment, in the communication system of the present invention the encryption key is generated based upon one or more ciphering key (Kc) generated during EAP/GSM authentication.

The access points 128A, 128B, 128C, required to work with the communication system 100 of the present invention must contain WLAN based authentication and session encryption support. The access point points 128A, 128B, 128C, will also be required to act as a RADIUS client to the RADIUS system 210 or server 212 and as a Network Access Server (NAS) in user authentication processes, causing EAP messages to be exchanged via RADIUS messaging. Two vendors offering access points 128A, 128B, 128C, meeting the above specifications include Proxim Inc., of Sunnyvale, Calif., and Cisco Inc., of San Jose, Calif.

In addition to the above, preferably the communication system 100 further includes a RADIUS server 212 capable of performing following functions:

Interface with the access points 128A, 128B, 128C, for authentication of private UEs 130, through interpretation of either a Username field or a EAP User Identity field in the RADIUS authentication request 298.

Route the authentication request to the appropriate authentication server 228.

Act as a proxy to the public HLR/VLR 144 or to an external RADIUS system 210 or private HLR 216 if roaming is enabled, by routing of user authentication request to the appropriate HLR based upon information contained in the Username field.

Where the public or private HLR 144, 216, is a central HLR, the RADIUS Server 212 will act as a proxy to forward authentication request to the HLR.

Where the public or private HLR 144, 216, is a distributed HLR, the RADIUS Server 212 could be adapted to contact the correct HLR in either of the following ways:

1. Query a standalone Central Address Table (CAT) Server (not shown) to match the HLR corresponding to subscriber IMS1; or

2. Use a configuration table (not shown) that matches IMSI ranges of the UE 130 with the controlling HLR. (This model works if IMS1 partitioning is implicitly or explicitly enabled for subscriber provisioning across multiple HLRs)

Receive RADIUS accounting packets generated by different access points 128A, 128B, 128C.

Forward accounting packets to a billing server (not shown) through a EAP interface 222.

Forward a copy of the accounting packets to the UE 1320 home RADIUS server 212 or accounting server for the case of roaming subscribers.

Preferably, the RADIUS or private HLR 216 supports all of the following attributes or capabilities:

Ability to enable/Disable WLAN 128 access for a particular UE 130, based upon subscriber IMSI.

Ability to re-authenticate the subscriber with the WLAN 128 upon timer the session timer expiry at the access point 128A, 128B, 128C. (Session timeout value)

Ability to use an algorithm to authenticate a subscriber to the WLAN 128. (Authentication algorithm)

Ability to notify the user with an operator defined message with appropriate text whenever WLAN access or authentication is attempted. (Notification message)

Ability to specify the maximum inactivity time after which the UE 130 will be assumed to wandered from out of the range of access point 128A, 128B, 128C, and removed from active user list. (Idle Timeout)

Ability to specify the maximum number of consecutive failed authentication attempts before the UE 130 will be disabled from WLAN access. (Retry limit)

More preferably, the RADIUS or private HLR 216 of the communication system 100 will support following Read-only attributes:

Ability to store information about the MAC address of the UE 130 used by the subscriber to access WLAN 128. (Calling Station Id)

Ability to provide the date and time when last authentication attempt was made on WLAN 128. (Last Access Time)

Ability to provide the date and time when last successful WLAN 128 authentication happened for the UE 130.(Last Successful access time)

Ability to provide other miscellaneous connection information passed by the access point 128A, 128B, 128C, e.g., connected on 802.11b at 10 MBPS etc. (Connect Information)

As noted above, the RADIUS or private HLR 216 will communicate with the RADIUS server 212 using an EAP interface only. This will avoid use, creation and maintenance of a proprietary protocol between RADIUS server and the HLR. To support the EAP interface 222:

An MD5 algorithm is implemented to verify the identity of the RADIUS server 212 acting as proxy to the public or private HLR, and to derive the user information from the encrypted message.

The EAP interface listens on well-known RADIUS server port, and processes only those RADIUS messages that contain EAP attributes to perform an EAP authentication (Identity request, access challenge(s), EAP success or failure) procedure to complete user authentication

Frames RADIUS access accept message with all the useful WLAN subscriber profile information provisioned at the public or private HLR.

Finally, in one embodiment, a subscriber management user interface (SMGUI 314) is provided to allow provisioning of the WLAN 128 service attributes including, for example, display of read-only attributes of the communication system 100. In one version of this embodiment, the display of the SMGUI 314 could be auto refreshed using an asynchronous mechanism with the private HLR 216. Alternatively, for simplicity of implementation, a refresh button on the SMGUI 314 could be used to get updates from the private HLR 216

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best use the invention and various embodiments with various modifications as are suited to the particular use contemplated. It is intended that the scope of the invention be defined by the claims appended hereto and their equivalents.

[image]

[image]

[image]

We claim:

1. A communication system comprising:
a public cellular network; and
at least one Wireless Local Area Network (WLAN) coupled to the public cellular network, the WLAN configured to facilitate communication between User Equipment terminals (UEs) and the public cellular network.

2. A communication system according to claim 1, wherein the public cellular network comprises a Global System for Mobile communications (GSM) network coupled to a Public Switched Telephone Network (PSTN).

3. A communication system according to claim 2, wherein the public cellular network further comprises a third-generation mobile communications (3G) network coupled to the GSM network and to the Internet, and wherein the WLAN is configured to facilitate communication between UEs and the GSM network and the 3G-network.

4. A communication system according to claim 2, further comprising a private cellular network coupled to the GSM network via a private A-link, and wherein the WLAN is coupled to the private cellular network to facilitate communication between the UEs and mobile stations associated with the private cellular network.

5. A communication system according to claim 1, wherein the public cellular network comprises a third-generation mobile communications (3G) network.

6. A communication system according to claim 5, wherein the public cellular network further comprises a Global System for Mobile communications (GSM) network, and wherein the WLAN is configured to facilitate communication between UEs and the GSM network and the 3G-network.

7. A communication system according to claim 2, further comprising a private cellular network coupled to the 3G-network, and wherein the WLAN is coupled to the private cellular network to facilitate communication between the UEs and mobile stations associated with the private cellular network.

8. A communication system according to claim 1, further comprising a private branch exchange (PBX), and wherein the WLAN is coupled to the PBX to facilitate communication between the UEs and telephones associated with the PBX.

9. A communication system according to claim 1, further comprising a Remote Authentication Dial In User Service (RADIUS) server to authenticate UEs accessing the communication system through the WLAN and to authorize access to the communication system.

10. A communication system according to claim 9, further comprising:
a plurality of WLANs;
a home location registry (HLR) and visitor location registry (VLR) coupled to the RADIUS server; and
wherein the RADIUS server is adapted to provide roaming capabilities for the UEs among the plurality of WLANs.

11. A communication system according to claim 10, wherein the RADIUS server is coupled to the HLR and VLR through a VLR/RADIUS (VRAD) interface.

12. A communication system according to claim 1, wherein the communication between the UEs and the public cellular network facilitated by the WLAN includes voice communication.

13. A communication system according to claim 12, wherein the UE comprises a computer program to enable the UE to control supplementary services for the UEs provided by the public wireless network.

14. A communication system according to claim 13, wherein the supplementary services provided include supplementary services from the group consisting of:
Voice Group Call Service;
Voice Broadcast Service;
Service definition Line Identification Supplementary Services;
Call Forwarding Supplementary Services;
Call Waiting and Call Hold Supplementary Services;
Multiparty call conferencing;
Closed User Group Supplementary Services;
Advice of Charge Supplementary Services;
Call Barring Supplementary Services;
Unstructured Supplementary Service Data;
Explicit Call Transfer;
Completion of Calls to Busy Subscriber;
Short Message Service; and
Follow Me.

15. A communication system according to claim 12, wherein the UE comprises a computer program to enable the UE to control value added services for the UEs provided by the public wireless network.

16. A communication system according to claim 15, wherein the supplementary services provided include supplementary services from the group consisting of:
e-mail, calender, and wireless inventory;
calender; and
wireless inventory.

17. A communication system according to claim 1, wherein the WLAN is compatible with a communication standard selected from a group consisting of:
High Performance Local Area Network (HiperLAN/1);
High Performance Local Area Network (HiperLAN/2);
High Performance Metropolitan Access Network (HiperMAN); and
Institute of Electrical and Electronics Engineers 802.11 (IEEE 802.11).

18. A communication system according to claim 1, wherein the WLAN is coupled to the public cellular network via an interface selected from a group consisting of:
IubisWLAN interfaces;
IuPSWLAN interfaces;
AbisWLAN interfaces;
AWLAN interfaces;
BTSWLAN interfaces; and
NodeBWLAN interfaces.

19. In a communication system including a public cellular network having a Global System for Mobile communications (GSM) network coupled to a Public Switched Telephone Network (PSTN), and a third-generation mobile communications (3G) network coupled to the GSM network and to the Internet, and a Wireless Local Area Network (WLAN) coupled to the GSM network and the 3G-network, a method of enabling a plurality of User Equipment terminals (UEs) to communicate with the public cellular network via the WLAN, the method comprising steps of:
receiving in the WLAN call information for one of the plurality of UEs;
providing subscriber identification and security information for the UE to an authentication server in the communication system; and
coupling the UE to the public cellular network over the WLAN.

20. A method according to claim 19, wherein the communication between the UEs and the public cellular network facilitated by the WLAN includes voice communication.

21. A method according to claim 19, wherein the UE further comprises a computer program to control supplementary services for the UEs provided by the public cellular network, and wherein the method further includes the step of accessing supplementary services for the UE provided by the public cellular network.

22. A method according to claim 19, wherein the UE further comprises a computer program to control supplementary services for the UEs provided by the public cellular network, and wherein the method further includes the step of accessing value added services for the UE provided by the public cellular network.

23. A method according to claim 19, wherein the UE comprises a memory system having subscriber identification and security information stored therein, and wherein the step of providing subscriber identification and security information for the UE to an authentication server in the communication system comprises the step of providing subscriber identification and security information from the memory system.

24. A method according to claim 19, wherein the UE is coupled to a card holder/reader holding a subscriber identity module (SIM), and wherein the step of providing subscriber identification and security information for the UE to an authentication server in the communication system comprises the step of reading subscriber identification and security information stored in the card held in the card holder/reader.

25. A communication system comprising:
a public network including:
a Global System for Mobile communications (GSM) network coupled to a Public Switched Telephone Network (PSTN); and
a third-generation mobile communications (3G) network coupled to the GSM network and to the Internet,
a private network including a private cellular network; and
at least one Institute of Electrical and Electronics Engineers 802.11 (802.11) network coupled to the public network and the private network, the 802.11 network configured to facilitate communication between a plurality of User Equipment terminals (UEs) and terminals coupled to the public network and the private network.

26. A communication system according to claim 25, wherein the communication between the UEs and the public cellular network facilitated by the 802.11 network includes voice communication.

27. A communication system according to claim 25, wherein the UEs associated with the 802.11 network comprise a computer program to enable the UEs to control supplementary services provided by the public network and the private network.

28. A communication system according to claim 25, wherein the UEs include low-power unregulated transceivers.

29. A communication system according to claim 25, wherein the terminals coupled to the public network and the private network include telephones, GSM mobile stations, and 3G UEs.

30. A communication system according to claim 25, wherein the private network further comprises a private branch exchange (PBX), and wherein the terminals coupled to the private network include PBX telephones.

31. A communication system according to claim 25, further comprising a Remote Authentication Dial In User Service (RADIUS) server to authenticate UEs accessing the communication system through the 802.11 network and to authorize access to the communication system.

32. A communication system according to claim 31, further comprising:
a plurality of 802.11 networks;
a home location registry (HLR) and visitor location registry (VLR) coupled to the RADIUS server; and
wherein the RADIUS server is adapted to provide roaming capabilities for the UEs among the plurality of 802.11 networks.

33. A communication system according to claim 25, wherein the private cellular network includes a mobile switching center (MSC), and wherein the 802.11 network is coupled to the public network through the MSC.

34. A communication system according to claim 33, wherein the 3G-network includes a Radio Network Controller (RNC) and wherein the 802.11 network is coupled to the RNC via an Iubis802.11 interface.

35. A communication system according to claim 33, wherein the 3G-network includes a node B and wherein the 802.11 network is coupled to the node B via an NodeB802.11 interface.

36. A communication system according to claim 33, wherein the 3G-network includes a third-generation Gateway General Packet Radio Service (GPRS) Support Node (3G-GGSN), and wherein the 802.11 network is coupled to the 3G-GGSN via an IuPS802.11 interface, the Internet and a Gi interface.

37. A communication system according to claim 33, wherein the 3G-network includes a GPRS Serving GPRS Support Node (GPRS-SGSN) and wherein the 802.11 network is coupled to the GPRS-SGSN via an IuPS802.11 interface.

38. A communication system according to claim 32, wherein the 3G-network includes a third-generation Serving GPRS Support Node (3G-SGSN) and wherein the 802.11 network is coupled to the 3G-SGSN via the GPRS-SGSN and the IuPS802.11 interface.

39. A communication system according to claim 33, wherein the GSM includes a Base Transceiver Station (BTS) and wherein the 802.11 network is coupled to the BTS via an BTS.11 interface.

40. A communication system according to claim 33, wherein the GSM includes a Base Station Controller (BSC) and wherein the 802.11 network is coupled to the BSC via an Abis802.11 interface.

41. A communication system according to claim 33, wherein the GSM includes a Mobile Switching Center (MSC) and wherein the 802.11 network is coupled to the MSC via an A802.11 interface.

42. A communication system according to claim 33, wherein the 802.11 network further comprises a number of access points coupled to the MSC of the private cellular network through a local area network (LAN), and wherein the private network is configured to facilitate communication between terminals connected to the LAN and the public network and the private network.
